(19) United States
(12) Patent Application Publication
(10) Pub. No.: US 2016/0049651 A1
(43) Pub. Date: Feb. 18, 2016

(54) NEGATIVE ELECTRODE FOR NONAQUEOUS ELECTROLYTE SECONDARY BATTERY AND NONAQUEOUS ELECTROLYTE SECONDARY BATTERY

(71) Applicant: SANYO ELECTRIC CO., LTD., Osaka (JP)

(72) Inventors: Shouichiro Sawa, Tokushima (JP); Ayano Toyoda, Osaka (JP); Taizou Sunano, Hyogo (JP)

(73) Assignee: SANYO ELECTRIC CO., LTD., Daito-shi, Osaka (JP)

(21) Appl. No.: 14/779,824

(22) PCT Filed: Mar. 18, 2014
(86) PCT No.: PCT/JP2014/001535

§ 371 Date: Sep. 24, 2015

(30) Foreign Application Priority Data
Mar. 26, 2013 (JP) 2013-065100

(51) Int. Cl. H01M 4/38; H01M 10/052

(52) U.S. Cl. CPC H01M 4/382; H01M 4/386; H01M 10/052; H01M 2220/20; H01M 2220/30

(57) ABSTRACT

A nonaqueous electrolyte secondary battery which has a good capacity retention ratio (cycle characteristics) and in which the expansion and shrinkage during charging and discharging are small compared with the case where a negative electrode made of only a negative electrode active material that forms an alloy with lithium is used. A negative electrode for a nonaqueous electrolyte secondary battery according to one aspect of the present invention includes a negative electrode mixture layer formed on a current collector and containing a binder and a negative electrode active material particle that forms an alloy with lithium. The negative electrode mixture layer includes pillar portions, and a value of S1/S2 is 0.46 or more and 0.58 or less, where S1 represents a total area of the pillar portions in plan view and S2 represents a total area of one surface of the negative electrode current collector in plan view.

### TECHNICAL FIELD

The present invention relates to a negative electrode for nonaqueous electrolyte secondary batteries and a nonaqueous electrolyte secondary battery that uses the negative electrode.

### BACKGROUND ART

In order to increase the energy density and output of nonaqueous electrolyte secondary batteries, a study on using, as a negative electrode active material, a material that forms an alloy with lithium, such as silicon, germanium, tin, or zinc, instead of a carbon material such as graphite has been conducted in recent years. However, a negative electrode that uses a material containing silicon or the like as a negative electrode active material undergoes considerable volume expansion or shrinkage during occlusion and release of lithium. Therefore, in nonaqueous electrolyte secondary batteries including a negative electrode that uses a material containing silicon as a negative electrode active material, swelling of cells, formation of fine powder of a negative electrode active material, and detachment of a negative electrode active material from a current collector by stress occur as the charge-discharge cycle proceeds, resulting in degradation of cycle characteristics.

PTL 1 below discloses a nonaqueous electrolyte secondary battery that uses a negative electrode obtained by forming a plurality of pillar-shaped protruding portions on a thin film that is made of a negative electrode active material such as silicon and deposited on a negative electrode current collector. The plurality of pillar-shaped protruding portions are made of a negative electrode active material such as silicon and have a larger thickness than portions around the protruding portions.

The negative electrode in the nonaqueous electrolyte secondary battery disclosed in PTL 1 below is obtained by forming a silicon thin film serving as a base layer on a surface of a negative electrode current collector by a sputtering method and furthermore forming pillar-shaped protruding portions made of silicon on the surface of the silicon thin film by a lift-off method including sputtering and etching in a combined manner. The negative electrode has cavities that absorb the volume expansion of the negative electrode active material during charging and discharging around the pillar-shaped protruding portions, whereby the swelling of cells is suppressed and a large stress is prevented from being applied to the negative electrode current collector.

### CITATION LIST

### Patent Literature

PTL 1: Japanese Published Unexamined Patent Application No. 2003-303586

### SUMMARY OF INVENTION

### Technical Problem

In the nonaqueous electrolyte secondary battery that uses the negative electrode disclosed in PTL 1 above, wrinkling caused on the negative electrode current collector by charging and discharging is suppressed, the swelling of cells is small, and the volumetric energy density is high. In the nonaqueous electrolyte secondary battery that uses the negative electrode disclosed in PTL 1 above, however, further improvements can be made in capacity retention ratio (cycle characteristics).

### Solution to Problem

A negative electrode for a nonaqueous electrolyte secondary battery according to one aspect of the present invention includes a current collector and a negative electrode mixture layer formed on the current collector and containing a binder and a negative electrode active material particle that forms an alloy with lithium. In an uncharged state, the negative electrode mixture layer includes pillar portions, and a value of S1/S2 is 0.46 or more and 0.58 or less, where S1 represents a total area of the pillar portions in plan view and S2 represents a total area of one surface of the negative electrode current collector in plan view.

### Advantageous Effects of Invention

In the negative electrode for a nonaqueous electrolyte secondary battery according to one aspect of the present invention, even if the negative electrode active material particle expands during charging, the expansion is absorbed by cavities formed between the pillar portions of the negative electrode mixture layer. This also decreases the stress applied to the negative electrode current collector. Furthermore, even if the negative electrode active material particle expands and shrinks as a result of charging and discharging, the bonds between the negative electrode active material particles and between the negative electrode active material and the current collector are maintained by the binder. Therefore, the electron conductivity between the negative electrode active material particles and the electron conductivity between the negative electrode active material and the current collector are maintained. Thus, a nonaqueous electrolyte secondary battery having a good capacity retention ratio is obtained by using the negative electrode for a nonaqueous electrolyte secondary battery according to one aspect of the present invention.

Furthermore, in the negative electrode for a nonaqueous electrolyte secondary battery according to one aspect of the present invention, a value of S1/S2 is 0.46 or more and 0.58 or less, where S1 represents a total area of the pillar portions in plan view and S2 represents a total area of one surface of the negative electrode current collector in plan view. Thus, a portion of the negative electrode active material that has expanded during charging is prevented from protruding from the cavities formed between the pillar portions of the negative electrode mixture layer, and consequently the negative electrode mixture layer easily returns to the original state. Therefore, in the nonaqueous electrolyte secondary battery that uses the negative electrode for a nonaqueous electrolyte secondary battery according to one aspect of the present invention, the expansion percentage in the thickness direction during charging is small and a good capacity retention ratio is achieved. The term “in plan view” in this specification means that, when a negative electrode is placed on a flat surface, the negative electrode is viewed from the above.

### BRIEF DESCRIPTION OF DRAWINGS

FIG. 1 schematically illustrates a pillar-portion-forming die according to Experimental Example 3.

FIG. 2 schematically illustrates a pillar-portion-forming die according to Experimental Example 4.

FIG. 3 schematically illustrates a pillar-portion-forming die according to Experimental Example 5.

FIG. 4 schematically illustrates a monopolar cell used in each of Experimental Examples.

FIG. 5A is an electron microscope image illustrating a negative electrode of Experimental Example 3 before initial charging and FIG. 5B is an electron microscope image after the initial charging.

FIG. 6A is a schematic longitudinal-sectional view corresponding to FIG. 5A and FIG. 6B is a schematic longitudinal-sectional view corresponding to FIG. 5B.

FIG. 7A is an electron microscope image illustrating a portion corresponding to FIG. 5A after initial discharging and FIG. 7B is an electron microscope image illustrating the portion corresponding to FIG. 5A after third-cycle discharging.

### DESCRIPTION OF EMBODIMENTS

Hereafter, an embodiment of the present invention will be described in detail on the basis of Experimental Examples. The following Experimental Examples merely show one example of a negative electrode for nonaqueous electrolyte secondary batteries that embodies the technical idea of the present invention. The present invention is not intended to be limited to any of Experimental Examples. The present invention is equally applicable to various modifications without departing from the technical idea provided in the claims.

### [Preparation of Negative Electrode Mixture Slurry]

A negative electrode mixture slurry used in each of Experimental Examples 1 to 5 was prepared by mixing silicon particles having an average particle diameter (D₅₀) of 3 μm and serving as a negative electrode active material, a graphite powder having an average particle diameter (D₅₀) of 3 μm and serving as a negative electrode conductive material, and a polyamic acid resin which is a precursor of a polyimide resin and serves as a negative electrode binder using N-methylpyrrolidone (NMP) as a dispersion medium. The mass ratio of the materials in the mixing was 84.4:5.4:10.2, and the solid content of the slurry was 47 mass %.

### Experimental Example 1

The prepared negative electrode mixture slurry was applied in a solid manner onto an electrolytically roughened surface of a copper alloy foil (C7025 alloy foil, composition: Cu 96.2 mass %, Ni 3 mass %, Si 0.65 mass %, and Mg 0.15 mass %) having a thickness of 18 μm and serving as a negative electrode current collector using a glass substrate applicator in the air at 25° C., and dried. The surface roughness Ra (JIS B 0601-1994) of the copper alloy foil was 0.25 μm, and the average distance between local peaks S (JIS B 0601-1994) of the surface of the copper alloy foil was 0.85 μm.

A heat treatment was then conducted at 400° C. for 10 hours to convert the polyamic acid resin into a polyimide resin and to perform sintering. Subsequently, the sintered product was cut into a size of 20×27 mm², and then a Ni plate serving as a collector terminal was attached thereto to produce a negative electrode of Experimental Example 1. The density of the negative electrode mixture layer in the negative electrode of Experimental Example 1 was 0.85 g/cm³.

### Experimental Example 2

The prepared negative electrode mixture slurry was applied in a solid manner onto a surface of the copper alloy foil using a glass substrate applicator in the same manner as in Experimental Example 1 so as to have the same thickness as in Experimental Example 1, and dried. Subsequently, a negative electrode of Experimental Example 2 was produced in the same manner as in the negative electrode of Experimental Example 1, except that the density of the negative electrode mixture layer was increased by rolling. The density of the negative electrode mixture layer in the negative electrode of Experimental Example 2 was 1.5 g/cm³.

### Experimental Examples 3 to 5

The prepared negative electrode mixture slurry was applied onto a surface of the same copper alloy foil as in Experimental Example 1 using a glass substrate applicator so as to have the same thickness as in Experimental Example 1 and then semidried in a drying oven so that the NMP was left. A die (hereafter referred to as a “pillar-portion-forming die”) including a plurality of pores formed thereon was pressed against the surface of the semidried negative electrode mixture layer to perform molding. Then, the negative electrode mixture layer was completely dried.

A heat treatment was then conducted at 400° C. for 10 hours. The resulting product was cut into a size of 20×27 mm², and then a Ni plate serving as a collector terminal was attached thereto to produce a negative electrode of each of Experimental Examples 3 to 5 which includes a negative electrode mixture layer in which pillar portions are formed. The apparent mixture density of the entire negative electrode mixture layer was 0.6 g/cm³ (Experimental Example 3) and 0.65 g/cm³ (Experimental Examples 4 and 5). The apparent mixture density is a theoretical value calculated by including, when the density of the negative electrode mixture is determined, the volume of cavities formed as a result of the formation of pillar portions.

### (Pillar-Portion-Forming Die)

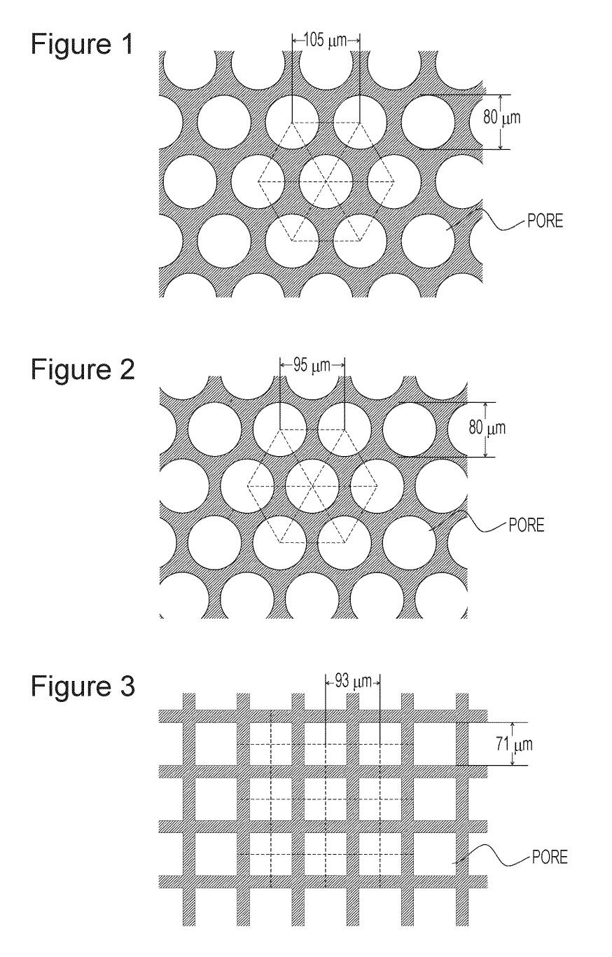

FIG. 1 to FIG. 3 schematically illustrate the difference in the shape, size, and arrangement of pores formed on the pillar-portion-forming dies in Experimental Examples 3 to 5. FIG. 1 illustrates a pillar-portion-forming die according to Experimental Example 3, FIG. 2 illustrates a pillar-portion-forming die according to Experimental Example 4, and FIG. 3 illustrates a pillar-portion-forming die according to Experimental Example 5. Since FIG. 1 to FIG. 3 are drawings that show the difference in the shape, size, and arrangement of pores, the outer edge of the pillar-portion-forming die is not illustrated.

In Experimental Example 3, as illustrated in FIG. 1, a die in which the shape of pores is a circle having a diameter of 80 μm, the arrangement of pores is a hexagonal lattice arrangement with intervals of 105 μm (the centers of circles form a hexagonal lattice), and the thickness of pores is 36 μm was used as the pillar-portion-forming die according to Experimental Example 3.

In Experimental Example 4, as illustrated in FIG. 2, a die in which the shape of pores is a circle having a diameter of 80 μm, the arrangement of pores is a hexagonal lattice arrangement with intervals of 95 μm, and the thickness of pores is 36 μm was used as the pillar-portion-forming die according to Experimental Example 4.

In Experimental Example 5, as illustrated in FIG. 3, a die in which the shape of pores is a square with 71 μm sides, the arrangement of pores is a rectangular lattice arrangement with intervals of 93 μm (the centers of squares form a rectangular lattice), and the thickness of pores is 36 μm was used as the pillar-portion-forming die according to Experimental Example 5.

The hexagonal lattice arrangement or the rectangular lattice arrangement in this application is an arrangement in which unit figures (circles in Experimental Examples 3 and 4 and squares in Experimental Example 5) are periodically arranged at regular intervals when viewed in plan. In the hexagonal lattice arrangement, a particular unit figure is surrounded by other unit figures in six directions. When the centers of circles which each serve as a unit figure and have the shortest distance therebetween are joined with line segments, congruent regular triangles are formed (refer to FIG. 1 and FIG. 2). In the rectangular lattice arrangement, a particular unit figure is surrounded by other unit figures in four directions. When the centers of squares which each serve as a unit figure and have the shortest distance therebetween are joined with line segments, congruent squares are formed (refer to FIG. 3). The shape and size of the pillar portions of the negative electrode mixture layer in Experimental Examples 3 to 5 are substantially equal to the shape and size of pores formed on the pillar-portion-forming die used in Experimental Examples 3 to 5.

### [Preparation of Nonaqueous Electrolytic Solution]

Fluoroethylene carbonate (FEC) and methyl ethyl carbonate (MEC) were mixed at a volume ratio (FEC:MEC) of 2:8 in an argon atmosphere. Subsequently, lithium hexafluorophosphate (LiPF₆) was dissolved in the mixed solvent so as to have a concentration of 1 mol/L to prepare a nonaqueous electrolytic solution used for each of Experimental Examples 1 to 5.

### [Production of Monopolar Cell]

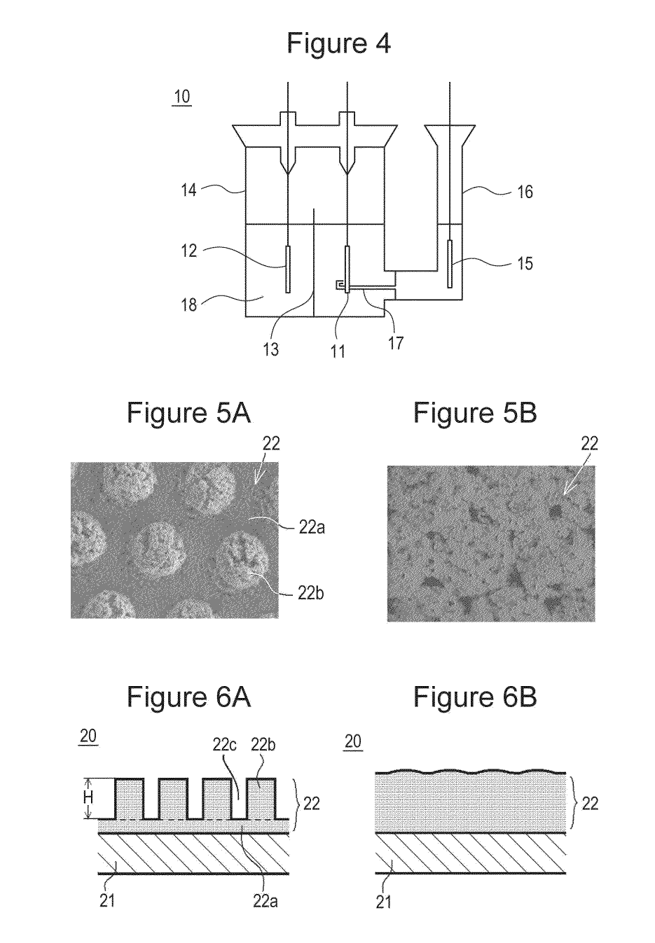

A lithium foil serving as a counter electrode (positive electrode) to which a nickel plate was attached as a terminal was disposed so as to face the produced negative electrode of each of Experimental Examples 1 to 5 with a separator disposed therebetween. They were sandwiched between a pair of glass substrates and immersed in the nonaqueous electrolytic solution. A lithium foil to which a nickel plate was attached as a terminal was used as a reference electrode. FIG. 4 schematically illustrates a monopolar cell.

A monopolar cell 10 illustrated in FIG. 4 includes a measurement cell 14 in which a negative electrode 11, a counter electrode (positive electrode) 12, and a separator 13 are disposed and a reference electrode cell 16 in which a reference electrode 15 is disposed. A capillary 17 extends from the reference electrode cell 16 to near the surface of the positive electrode 11. The measurement cell 14 and the reference electrode cell 16 are each filled with a nonaqueous electrolytic solution 18. In the actually produced monopolar cell 10, the negative electrode 11 of each of Experimental Examples 1 to 3, the separator 13, and the counter electrode (positive electrode) 12 are integrally sandwiched between a pair of glass substrates (not illustrated). However, the negative electrode 11, the separator 13, and the counter electrode (positive electrode) 12 are schematically illustrated in FIG. 4 in a separated manner in order to clearly show the measurement principle.

### [Measurement of Monopolar Characteristics]

A charge-discharge cycle test was performed on the produced monopolar cell according to each of Experimental Examples 1 to 5 under the following conditions. First, charging was performed at a constant current of 1.2 mA until the state of charge calculated on the basis of the following calculation formula reached 50%.

State of charge (%)=(charge capacity/(theoretical capacity of silicon×mass of negative electrode active material))×100

Since lithium can be intercalated into silicon up to the composition Li_{4.4}Si, the theoretical capacity of silicon is 4200 mAh/g. Therefore, the above formula can also be represented as follows.

State of charge (%)=(charge capacity/(4200×mass of negative electrode active material))×100

Furthermore, the thickness of the negative electrode mixture layer in the negative electrode of each of Experimental Examples 1 to 5 after the initial charging was measured with a micrometer.

Subsequently, discharging was performed at a constant current of 1.2 mA until the voltage reached 1000 mV vs. Li/Li⁺, and the quantity of electricity that flowed herein was determined as an initial discharge capacity. Furthermore, the thickness of the negative electrode mixture layer in the negative electrode of each of Experimental Examples 1 to 5 after the initial discharging was measured with a micrometer.

Subsequently, charging was performed under the same conditions as those of the initial charging. That is, charging was performed at a constant current of 1.2 mA until the state of charge reached 50%. Then, discharging was performed at a constant current of 1.2 mA until the voltage reached 1000 my vs. Li/Li⁺, and the quantity of electricity that flowed herein was determined as a second-cycle discharge capacity.

The expansion percentage of the negative electrode mixture layer in a thickness direction and the capacity retention ratio of the monopolar cell were determined on the basis of the calculation formulae below using the measured discharge capacity and the measured thickness of the negative electrode mixture layer.

Expansion percentage (%) of negative electrode mixture layer in thickness direction=((thickness of negative electrode mixture layer after initial charging/thickness of negative electrode mixture layer after initial discharging)−1)×100

Capacity retention ratio (%)=(second-cycle discharge capacity/initial discharge capacity)×100

Table 1 collectively shows the area percentages of pillar portions after discharging and after charging, the apparent density of the negative electrode mixture layer and the expansion percentage of the negative electrode mixture layer in a thickness direction, and the capacity retention ratio. Herein, the apparent density of the negative electrode mixture layer in Experimental Examples 1 and 2 in which pillar portions are not formed simply refers to a density of the negative electrode mixture layer. In an uncharged state or after the completion of discharging, the total area S1 of pillar portions in plan view is proportional to the total area of pores per unit area in the pillar-portion-forming die used. The total area S2 of one surface of the negative electrode current collector in plan view is proportional to the unit area in the pillar-portion-forming die used. Therefore, the area percentage of pillar portions in the negative electrode mixture layer after discharging is equal to (total area of pores per unit area)/(unit area) in the pillar-portion-forming die used.

TABLE 1

| | Pillar portion | | | | | Negative electrode mixture layer | | |
|---|---|---|---|---|---|---|---|---|
| | | | | Area percentage (%) | | Apparent | Expansion percentage | Capacity |
| | | Planar | Interval | After | After | density | in thickness direction | retention ratio |
| | Shape | arrangement | (μm) | discharging | charging | (g/cm³) | (%) | (%) |
| Experimental | — | — | — | 100 | 100 | 0.85 | 38 | 30 |
| Example 1 | | | | | | | | |
| Experimental | — | — | — | 100 | 100 | 1.50 | 100 | 10 |
| Example 2 | | | | | | | | |
| Experimental | Round | Hexagonal | 95 | 54 | 91 | 0.60 | 40 | 97 |
| Example 3 | pillar | lattice | | | | | | |
| Experimental | Round | Hexagonal | 105 | 58 | 100 | 0.65 | 55 | 95 |
| Example 4 | pillar | lattice | | | | | | |
| Experimental | Rectangular | Rectangular | 93 | 58 | 100 | 0.65 | 39 | 97 |
| Example 5 | parallelepiped | lattice | | | | | | |

The following is found from the results shown in Table 1. In Experimental Examples 3 to 5 in which pillar portions were formed in the negative electrode mixture layer, the capacity retention ratio markedly increases compared with Examples 1 and 2 in which the negative electrode mixture layer was formed in a solid manner. This clearly indicates that the capacity retention ratio (cycle characteristics) is considerably improved.

In Experimental Example 4, the area percentage after the charging is 100%, which means that the pillar portions adjacent to each other interfere with each other after the charging and the pillar portions originally having a round pillar shape are deformed by stress. This may affect the fact that the capacity retention ratio in Experimental Example 4 is slightly lower than those in Experimental Examples 3 and 5.

As illustrated in FIG. 5A and FIG. 6A, the negative electrode 20 of Experimental Example 3 includes a negative electrode mixture layer 22 obtained by forming a base portion 22a having a thin film shape and made of a negative electrode mixture on a surface of a negative electrode current collector 21 and forming pillar portions 22b having a substantially constant height H and made of a negative electrode mixture on the base portion 22a. Herein, the pillar portions 22b are arranged in a hexagonal lattice arrangement. When initial charging is performed in this state, as illustrated in FIG. 5B and FIG. 6B, negative electrode active material particles made of silicon in the negative electrode mixture layer 22 expand and the expansion of the negative electrode active material particles is absorbed by cavities 22c formed between the pillar portions 22b of the negative electrode mixture layer 22. Consequently, the height H of the negative electrode mixture layer 22 does not considerably increase.

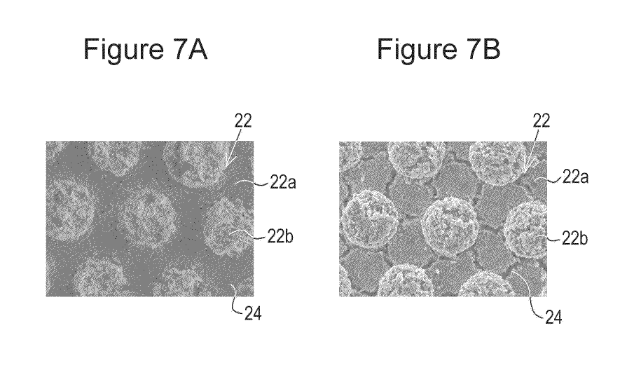

When initial discharging is performed in this state, a state illustrated in FIG. 7A is provided, which is substantially the same state as that before the initial charging. Herein, when FIG. 7A is carefully observed, it has been confirmed that honeycomb-shaped fine cracks 14 are formed on the base portion 22a in a radial manner from pillar portions 22b toward other pillar portions 22b. The cracks 24 are formed by the expansion of the negative electrode active material particles in the negative electrode mixture layer 22 during charging.

In the negative electrode 20 of Experimental Example 3, the cavities 22c formed by arranging, in a hexagonal lattice arrangement, a plurality of the pillar portions 22b formed on the base portion 22a of the negative electrode current collector 21 are maximally utilized, and thus the expansion of the negative electrode active material particles in the negative electrode mixture layer 22 is maximally absorbed by the cavities formed between the pillar portions 22b. Consequently, it is believed that a plurality of cracks between the pillar portions are formed in a radial manner, and the stress between the negative electrode active material particles and the stress between the negative electrode active material particles and the negative electrode current collector 21 are reduced, resulting in a good capacity retention ratio.

When silicon, which expands as a result of occlusion of lithium during charging, is contained as the negative electrode active material, it is effective to form the pillar portions 22b so as to be apart from each other to the extent that even when the pillar portions 22b expand in a width direction during charging, the pillar portions 22b adjacent to each other do not interfere with each other, for the purpose of maintaining the structure of the negative electrode mixture layer 22 as much as possible. Thus, even when the negative electrode active material particles expand as a result of charging, the pillar portions 22b do not interfere with each other. Therefore, the structure of the negative electrode mixture layer is maintained, which allows an improvement in the capacity retention ratio. On the other hand, the apparent mixture density of the negative electrode active material layer decreases as the distance between the pillar portions 22b increases. In view of energy density, the distance between the pillar portions 22b is preferably as short as possible.

In Experimental Example 5, the area percentage of the pillar portions after discharging is high, that is, the distance between the pillar portions can be decreased. Therefore, the capacity of the negative electrode is high and the capacity retention ratio is also high.

It is found from the results of Experimental Examples 3 to 5 that excellent results are obtained when the area percentage of the pillar portions is 58% or less after discharging. The extrapolation of the results of Experimental Examples 3 and 4 in consideration of energy density shows the following: when the area percentage (S1/S2) of the pillar portions is 46% to 58% in an uncharged state or after the completion of discharging, the area percentage reaches about 85% to 100% after charging and thus good results are believed to be obtained.

In Experimental Examples 1 to 5, a negative electrode mixture having a volume expansion percentage of 220% during charging and discharging was used. In the case where a negative electrode mixture having a volume expansion percentage of less than 220% is used, when the area percentage of the pillar portions is 58% or less after discharging, the same results as above are believed to be obtained.

In Experimental Examples 3 to 5, the case where the negative electrode mixture layer is obtained by forming a base portion having a particular thickness and made of a negative electrode mixture and forming pillar portions on the surface of the base portion has been described. However, in another aspect of the present invention, the pillar portions may be directly formed on the surface of the negative electrode current collector without forming the base portion. In Experimental Example 5, the case where the shape of the pillar portions is a prism having a square shape in plan view has been described, but the corners may be chamfered or may be rounded, or the shape in plan view may be a polygon.

In Experimental Examples 1 to 5, the case where the polyimide resin formed from a polyamic acid resin is used as a binder has been described, but the same effects are produced even when a well-known polyimide resin is used from the beginning. A binder composed of another compound commonly used in negative electrodes for nonaqueous electrolyte secondary batteries may also be used. When the polyimide resin is used as a binder, the negative electrode active material particles are bonded to each other with the polyimide resin having a high elastic modulus. Therefore, the negative electrode active material particles can flexibly expand toward the inside of the pillar portions and the cavities between the pillar portions during charging compared with the case where the polyimide resin is not used. Consequently, the damage to the electrode structure such as isolation of the negative electrode active material particles can be satisfactorily suppressed.

In Experimental Examples 1 to 5, the case where the silicon particles are used as the negative electrode active material has been described, but a material that forms an alloy with lithium, such as germanium, tin, or zinc, may be used instead of silicon. In Experimental Examples 1 to 5, the case where the silicon particles having an average particle diameter (D₅₀) of 3 μm are used as the negative electrode active material has been described, but the average particle diameter (D₅₀) of the silicon particles is preferably 13 μm or less and more preferably 6 μm or less, and preferably 2 μm or more. An excessively large particle diameter of the silicon particles makes it difficult to form the pillar portions. If the particle diameter of the silicon particles is small, the specific surface area increases. This increases the reactivity with the nonaqueous electrolytic solution and facilitates the oxidation of the negative electrode active material, which decreases the capacity retention ratio.

A positive electrode, a nonaqueous electrolyte, and a separator that can be used in the nonaqueous electrolyte secondary battery according to one aspect of the present invention will be described below as an example.

### [Positive Electrode]

The positive electrode suitably includes a positive electrode current collector and a positive electrode active material layer formed on the positive electrode current collector. The positive electrode active material layer preferably contains a conductive material and a binding agent in addition to a positive electrode active material. The positive electrode active material is not particularly limited, but is preferably a lithium transition metal oxide. The lithium transition metal oxide may contain a non-transition metal element such as Mg or Al. Specific examples of the lithium transition metal oxide include lithium cobaltate, olivine lithium phosphate such as lithium iron phosphate, and lithium transition metal oxides such as Ni—Co—Mn, Ni—Mn—Al, and Ni—Co—Al. These positive electrode active materials may be used alone or in combination of two or more.

### [Nonaqueous Electrolyte]

The nonaqueous electrolyte contains a nonaqueous solvent and an electrolyte salt dissolved in the nonaqueous solvent. The nonaqueous electrolyte is not limited to a liquid electrolyte (nonaqueous electrolytic solution), and may be a solid electrolyte that uses a gel polymer or the like. The nonaqueous solvent may be, for example, an ester, an ether, a nitrile (e.g., acetonitrile), or an amide (e.g., dimethylformamide) or a mixed solvent containing two or more of the foregoing. At least a cyclic carbonate is preferably used as the nonaqueous solvent, and both a cyclic carbonate and a chain carbonate are more preferably used. The nonaqueous solvent may also be a halogen substitution product obtained by substituting hydrogen atoms of a solvent with halogen atoms such as fluorine atoms.

The electrolyte salt is preferably a lithium salt. Examples of the lithium salt include LiPF₆, LiBF₄, LiAsF₆, LiN(SO₂CF₃)₂, LiN(SO₂CF₅)₂, and LiPF₆₋ₓ(CₙF₂ₙ₊₁)ₓ (1<x<6, n: 1 or 2). These lithium salts may be used alone or in combination of two or more. The concentration of the lithium salt is preferably 0.8 to 1.8 mol per 1 L of the nonaqueous solvent.

### [Separator]

A porous sheet having ion permeability and an insulating property is used as the separator. Specific examples of the porous sheet include microporous membranes, woven fabrics, and nonwoven fabrics. The separator is suitably made of a polyolefin such as polyethylene or polypropylene.

### INDUSTRIAL APPLICABILITY

The negative electrode for nonaqueous electrolyte secondary batteries according to one aspect of the present invention and the nonaqueous electrolyte secondary battery that uses the negative electrode can be applied to drive power supplies for mobile information terminals, such as cellular phones, notebook computers, and PDAs, that are particularly required to have high energy density. They are also promising for high-output uses such as electric vehicles (EVs), hybrid electric vehicles (HEVs or PHEVs), and power tools.

### REFERENCE SIGNS LIST

10 monopolar cell
11 negative electrode
12 counter electrode (positive electrode)
13 separator
14 measurement cell
15 reference electrode
16 reference electrode cell
17 capillary
18 nonaqueous electrolytic solution
20 negative electrode
21 negative electrode current collector
22 negative electrode mixture layer
22a base portion
22b pillar portion
22c cavity
24 crack

1. A negative electrode for a nonaqueous electrolyte secondary battery, comprising:
a current collector;
a negative electrode mixture layer formed on the current collector and containing a binder and a negative electrode active material particle that forms an alloy with lithium,
wherein in an uncharged state,
the negative electrode mixture layer includes pillar portions, and
a value of S1/S2 is 0.46 or more and 0.58 or less, where S1 represents a total area of the pillar portions in plan view and S2 represents a total area of one surface of the negative electrode current collector in plan view.

2. The negative electrode for a nonaqueous electrolyte secondary battery according to claim 1, wherein a shape of the pillar portions is a quadrangular prism.

3. The negative electrode for a nonaqueous electrolyte secondary battery according to claim 1, wherein the negative electrode active material particle is a Si-containing particle.

4. A nonaqueous electrolyte secondary battery comprising the negative electrode for a nonaqueous electrolyte secondary battery according to claim 1, a positive electrode containing a positive electrode active material, a separator, and a nonaqueous electrolyte.

5. The negative electrode for a nonaqueous electrolyte secondary battery according to claim 1, wherein the mixture layer contains a base portion having a thin film shape on a surface of the current collector, and the pillar portions are formed on the base portion.

6. The negative electrode for a nonaqueous electrolyte secondary battery according to claim 1, wherein the apparent mixture density of the negative electrode mixture layer is 0.6-0.65 g/cm³.
